(19) United States
(12) Patent Application Publication
(10) Pub. No.: US 2005/0105955 A1
(43) Pub. Date: May 19, 2005

(54) Longitudinal "one-hand" stick product distributor

(75) Inventors: Robert Petit, Cluny (FR); Marc Phu, Chevilly-Larue (FR)

Correspondence Address: DENNISON, SCHULTZ, DOUGHERTY & MACDONALD, 1727 KING STREET, SUITE 105, ALEXANDRIA, VA, 22314, US

(73) Assignee: Techpack International

(21) Appl. No.: 10/947,667

(22) Filed: Sep. 23, 2004

(30) Foreign Application Priority Data
Oct. 9, 2003 (FR) 0311820

(51) Int. Cl. H02K 37/00

(52) U.S. Cl. 401/77

(57) ABSTRACT

The distributor (1) intended to package a longitudinal stick product is provided with an axial propulsion mechanism (12) of the said longitudinal product, and comprises a) a cylindrical element called a “spiral” (2) provided with two helical grooves (20), b) a grooved tubular rod called a “guide” (3) with two opposed vertical grooves (30), c) a dish (4) acting as a support for the said longitudinal product, the said dish (4) comprising two pins (40), each radial pin (40) cooperating with a helical groove (20) through a vertical groove (30), and d) a means of closing off the upper opening of the distributor. This distributor is characterised in that:
1) it comprises a shell (5),
2) the said shell (5) comprises a lower part (51) that cooperates with the lower part (31) of the said guide (3),
3) the said shell (5) comprises a means of access to the said spiral (2), so that the said spiral (2) can be rotated manually,
4) the said distributor (1) comprises a cover (6) that can be opened or closed by the said manual rotation of the said spiral (2). Advantages: a “one-hand” distributor, provided with a standard propulsion mechanism is obtained.

### FIELD OF THE INVENTION

The invention relates to the field of stick product distributors that include a longitudinal body.

The invention relates to packagings of stick products, in other words packagings of solid or semi-solid products with sufficient consistency under normal temperature conditions to maintain their initial shape. It applies typically but not exclusively to packagings for lipstick or marking products, cosmetics, body care products, or pharmaceuticals used by applying the end of the said stick product locally onto a support to be treated, typically the skin, or lips in the special case of a tube of lipstick.

The invention more specifically relates to “one-hand” distributors since they can be opened and used with one hand, and when the said distributor is gripped with one hand, a mobile part of the distributor can also be manipulated to open the distributor and to move the said stick product in the axial direction, all using the same hand.

### STATE OF THE ART

A very large number of stick product distributors such as lipstick tubes or deodorant sticks are known.

Three main families of stick product distributors are already known for packaging of stick products, varying with the principle of the manually propulsion mechanism:
a first family includes a case that includes a support for the said stick with pins, and also in particular two coaxial parts, one provided with a helical groove and the other with an axial groove, such that relative rotation occurs between the two parts and causes axial displacement of the said stick. This type of propulsion mechanism is described for example in European Patent No. 1 039 942 related to a lipstick tube. A removable cap is necessary to protect the said stick in this type of case;
a second family includes a case with a sliding flexible element such as a tongue, in a U-shaped slide, one end of this element being fixed to the bottom of the said stick, its other end possibly closing off the open end of the said case. These are “one-hand” distributors since they can be used with a single hand to open them or close them, and to move the product stick as required;

For example, this type of propulsion mechanism is described in French patent No. 2 472 520;
finally, a third family used particularly in the case of deodorant sticks, makes use of a piston cooperating with a screw so that it can be moved by rotating a button fixed to the said screw.

For example, this type of propulsion mechanism is described in French patent No. 2 573 734.

Problems that Arise

It is advantageous if distributors form a non-dissociable assembly, so that they can be used with no risk of losing an element, in fact the cap.

Admittedly, distributors in the second family of packagings according to the state of the art mentioned above usually provide a solution to this problem.

But although distributors in this second “one-hand” family usually solve this problem, they have several types of disadvantages:
firstly, due to the necessity of making a tongue slide in a U-shaped slide without applying an excessive manual force, these packagings usually have a large clearance, which makes them very different in terms of manual feel from traditional lipstick tubes that form packagings in the first family according to the previous state of the art,
secondly, these distributors have a relatively large section over their entire height considering the space necessary for passage of the tongue and the slide for propulsion of the stick, which makes them significantly less slender and narrow than tubes according to the said first family of distributors,
finally, and perhaps because of the above, in practice distributors in the said second family are perceived, if not as down-market products, as being products that will be used to package sticks of less “noble” products than lipsticks.

The invention aims to solve these problems.

In particular, it aims to propose a new distributor that is in the said first family of distributors for the said propulsion mechanism, and can also be used with one hand like distributors in the second family.

This new distributor also aims to propose a distributor that is quite different in its appearance and its usage mode from distributors in the said second family, so as to be able to satisfy the ever increasing demand for new products, both in terms of the technical means used and their shape or their usage mode.

### DESCRIPTION OF THE INVENTION

According to the invention, the longitudinal distributor is provided with an axial propulsion mechanism for the said longitudinal product forcing it along an axial direction, to package a longitudinal stick product and typically a lipstick. It comprises a) a cylindrical element called a “spiral” provided with at least one helical groove on its inside surface and typically two helical grooves, b) a grooved tubular rod called a “guide” with at least one vertical groove and typically two opposed vertical grooves, the said guide forming a wall coaxial to the said spiral and located on the inside of the said spiral, c) a dish acting as a support for the said product, the said dish comprising at least one and typically two radial pins, each radial pin cooperating with a helical groove through a vertical groove, such that relative rotation of the said spiral with respect to the said guide along an axis of rotation parallel to the said axial direction causes axial displacement of the said dish and the said stick product and forces it to move outwards through an upper opening, and d) a means of closing off the said upper opening, and is characterised in that:
1) the said distributor comprises an outer shell or gripping case enclosing the said mechanism, the said shell comprising a typically cylindrical inner surface adapted to the said mechanism, the said shell being open in its upper part to allow the said product to pass through and possibly to form an assembly with the said mechanism,
2) the said shell comprises a lower part cooperating with the said lower part of the guide, such that the said guide is fixed particularly in rotation with respect to the said shell, the said spiral being mobile in rotation with respect to the said shell and the said guide,
3) the said shell comprises a means of access to the said spiral, so that when the said shell is gripped in one hand, the said spiral can be rotated manually with a finger of the same hand,
4) the said distributor comprises a cover that forms the said means of closing off the said upper opening, the said cover being fixed to the said shell at its top and that can be opened or closed by manual rotation of the said spiral, by a means of the said rotation of the said cover cooperating with the said spiral,
such that the said distributor is a “one hand” distributor, the said manual rotation of the said spiral through an angle α with respect to the said shell, typically being made using one finger of the said hand or a distal phalange of the said finger, the said manual rotation comprising firstly a “forward” rotation causing a “forward” rotation of the said cover in order to disengage the said upper opening, and then extension of the said stick product by axial displacement outside the distributor, and finally, after the said stick product has been applied, including a “backward” or inverse manual rotation of the said spiral, making the said stick product retract into the distributor, and a “backward” rotation of the said cover to close off the said upper opening.

The distributor according to the invention solves the problems that arise. Firstly, the presence of an outer shell shelters the said propulsion mechanism. Thus, by using the same propulsion mechanism, which may be largely a standard mechanism, it is possible to obtain a wide variety of shapes for the outer appearance, the outer shape of the said distributor being largely the same shape as the said shell.

Due to a recess, this shell thus provides access to the said spiral, such that the manual rotation of the said spiral with respect to the said shell (the said guide being fixed to the said shell) enables classical axial displacement of the said stick product.

Furthermore, the said distributor comprises a cover fixed to the said shell, which may be opened or closed by simple manual rotation of the said spiral, such that the distributor according to the invention forms a “one-hand” distributor.

### DESCRIPTION OF THE FIGURES

All figures relate to the invention.

FIGS. 1a to 8g relate to the same embodiment of the distributor (1). In this embodiment, the said lateral recess (52) is a median recess (52′) located between the said top part (50) and the said bottom part (51) of the said shell (5).

FIGS. 1a to 2h relate to the distributor (1).

FIG. 1a is a perspective view of the distributor (1) in the inclined position, with its cover (6) open.

FIG. 1b is a top view of the distributor (1) in FIG. 1a.

FIG. 1c is a perspective view of the distributor (1) in the straight position and with its cover (6) closed.

FIG. 1d is a sectional view along the axial plane A-A in FIG. 1e.

FIG. 1e is a front view of the distributor (1) in FIG. 1c.

FIG. 1f is a side view of the distributor (1) in FIG. 1c.

FIG. 1g is a top view of the distributor (1) in FIG. 1c.

FIG. 1h is an enlarged view of part f surrounded by a square frame in FIG. 1d.

FIG. 2a is a sectional view along axial plane B-B in FIG. 1d.

FIG. 2b is an enlarged view h of part h surrounded by a rectangular frame in FIG. 2a.

FIG. 2c is a sectional view along the horizontal plane D-D in FIG. 1d.

FIG. 2d is an enlarged view of the part surrounded by a rectangular frame in FIG. 2c.

FIG. 2e is a sectional view along the horizontal plane C-C in FIG. 1d.

FIG. 2f is a view of a section along the axial plane E-E in FIG. 1g.

FIG. 2g is a sectional view along the horizontal plane F-F in FIG. 2f.

FIG. 2h is an enlarged view of part n surrounded by a rectangular frame in FIG. 2g.

FIGS. 3a to 3j relate to the shell (5) of the distributor (1).

FIG. 3a is a perspective view.

FIG. 3b is a sectional view along axial plane B-B in FIG. 3g.

FIG. 3c is a sectional view along the horizontal plane E-E in FIG. 3b.

FIG. 3d is an enlarged view k of the part surrounded by a rectangular frame in FIG. 3c.

FIG. 3e is a view of the part surrounded by a rectangular frame in FIG. 3b enlarged 5 times.

FIG. 3f is a sectional view along the axial plane A-A in FIG. 3i.

FIG. 3g is a front view of the shell (5).

FIG. 3h is a sectional view along the horizontal plane C-C in FIG. 3g.

FIG. 3i is a side view of the shell (5).

FIG. 3j is a top view of the shell (5).

FIG. 3k is a bottom view of the shell (5).

FIGS. 4a to 4g relate to the spiral (2) of the distributor (1).

FIG. 4a is the view of a section along the axial plane A-A in FIG. 4b.

FIG. 4b is a side view of the said spiral (2).

FIG. 4c is an enlarged view of the part surrounded by a rectangular frame in FIG. 4a.

FIG. 4d is a top view of the spiral (2) in FIG. 4b.

FIG. 4e is an enlarged view f of the part surrounded by a square frame in FIG. 4d.

FIG. 4f is a perspective top view of the spiral (2) in FIG. 4b or 4c.

FIG. 4g is an enlarged view b of the part surrounded by a rectangular frame in FIG. 4f.

FIGS. 5a to 5g relate to the guide (3) of the distributor (1).

FIG. 5a is a top perspective view of the guide (3).

FIG. 5b is a side view.

FIG. 5c is another side view after rotation of the view in FIG. 5b by 90°.

FIG. 5d is a bottom view.

FIG. 5e is an enlarged view i of the part surrounded by a rectangular frame in FIG. 5d.

FIG. 5f is a view of an axial section along plane A-A in FIG. 5b.

FIG. 5g is an enlarged view g of the part surrounded by a rectangular frame in FIG. 5f.

FIGS. 6a to 6e relate to the dish (4) of the distributor (1).

FIG. 6a shows two perspective views of the dish (4).

FIG. 6b is a side view.

FIG. 6c is a sectional view along axial plane A-A in FIG. 6b.

FIG. 6d is a top view.

FIG. 6e is an enlarged view of FIG. 6c.

FIG. 6f corresponds to FIG. 6b after an axial rotation of 90°.

FIG. 6g is a view of a section along axial plane B-B in FIG. 6f.

FIGS. 7a to 7f relate to the cover (6) of the distributor (1).

FIG. 7a is a perspective side and bottom view.

FIG. 7b is a side view.

FIG. 7c is an enlarged view e of FIG. 7b.

FIG. 7d is another side view corresponding to the view in FIG. 7b after an axial rotation of 90°.

FIG. 7e is a bottom view of the cover (6) in FIG. 7d.

FIG. 7f is an enlarged view f of the part surrounded by a rectangular frame in FIG. 7e.

FIGS. 8a to 8g relate to the cache (7) of the distributor (1).

FIG. 8a is a perspective view.

FIG. 8b is a top view.

FIG. 8c is a side view.

FIG. 8d is a bottom view.

FIG. 8e is a side view corresponding to the view in FIG. 8c after a 90° axial rotation.

FIG. 8f is the view of a section along axial plane A-A in FIG. 8e.

FIG. 8g is an enlarged view g of FIG. 8f.

FIG. 9 illustrates operation of the distributor (1) when the distributor (1) is opened, with the angle α considered by convention to be equal to zero when the distributor is closed, being gradually increased by manual rotation of the said spiral (2), the said shell (5) being fixed since it is held in the hand.

Part A illustrates the elevation H of the said dish (4) and the extension of the stick product, starting from an angle α₃.

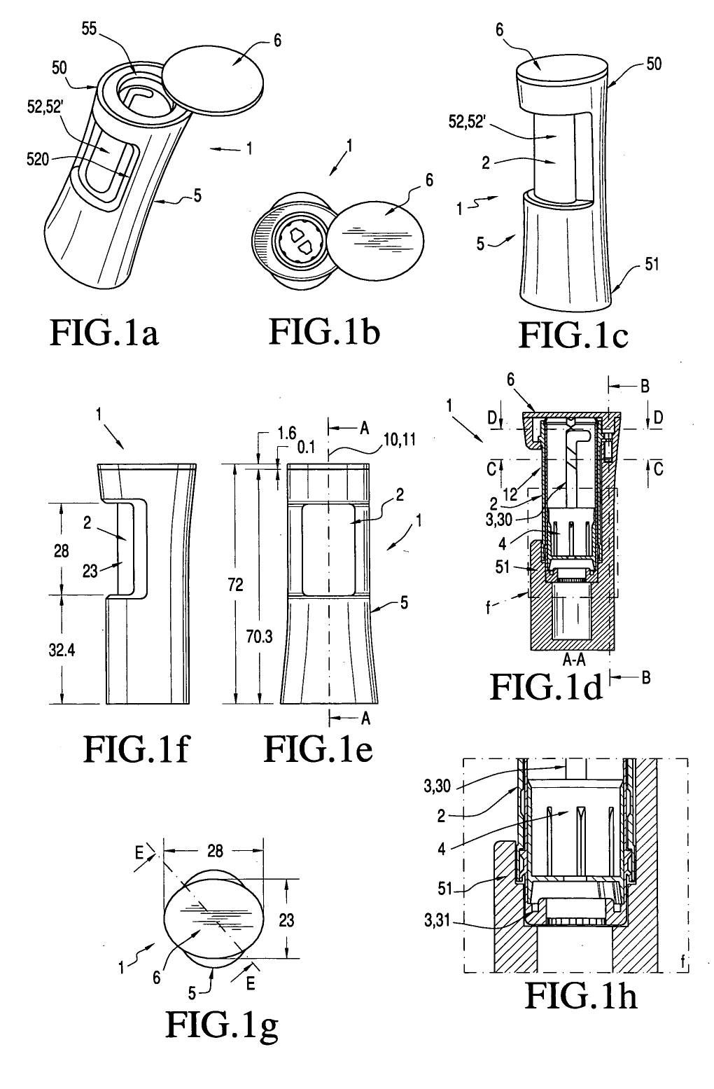

Part B indicates numeric values of the different angles α in the case of the distributor (1) corresponding to FIGS. 1a to 8g.

Part C indicates the axial spacing e of the cover before its rotation, which takes place for a varying from 0 to α₁, the cover maintaining axial spacing e while the cover is opened between angles α₁ and α₂ and then returning to its original axial position for an angle α equal to 50° (solid line), or keeping its axial spacing e>0 (dashed line) during subsequent rotation of the spiral (2).

Part D illustrates rotation of the cover by an angle β when the angle α changes from α₁ to α₂, the angle β then changing from to 0 to 180°.

FIGS. 10a to 10c illustrate another embodiment of the distributor (1) according to the invention.

In this embodiment, the said lateral recess (52) is a top recess (52″) located at the said top part (50) of the said shell (5).

FIG. 10a is a side view of a first variant of the shell (5) of the distributor (1).

FIG. 10b, similar to FIG. 10a, relates to a second variant of the distributor shell (5), the same propulsion mechanism (12) being used for the two distributors (1) in FIGS. 10a and 10b, since they both occupy the same internal volume in the said shell (5).

FIGS. 10a and 10b represent the top of the distributor (1) showing a diagrammatic top view with the cover (6) being removed.

The distributors (1) in FIGS. 10a and 10b have a symmetrical shape: the shape of the cover (6) reproduces the shape of the bottom (53) of the shell (5).

FIG. 10c illustrates another embodiment of guide means (24) and (62), the wheel (23) of the spiral (2) being provided with a groove forming the said female element (241) cooperating with a toothed wheel forming the said male element (620) of the said axial rod (61).

### DETAILED DESCRIPTION OF THE INVENTION

According to a first embodiment of the invention illustrated in FIGS. 1a to 8g, the said access means may comprise or may be composed of a median lateral recess (52) located between the said upper part (50) and the said lower part (51) of the said shell (5), over a height Ha equal to at least 20 mm and typically varying from 25 mm to 40 mm, so as to enable direct and easy access for the said finger or the said distal phalange.

However, according to a second embodiment of the invention illustrated in FIGS. 10b and 10c, the said access means may comprise or may be composed of an upper lateral recess (52′) located at the said upper part (50) of the said shell (5), over a height Ha′ typically varying from 3 mm to 15 mm.

Finally, as illustrated in FIG. 10a, the said access means may be composed of the said opening (55) of the said shell.

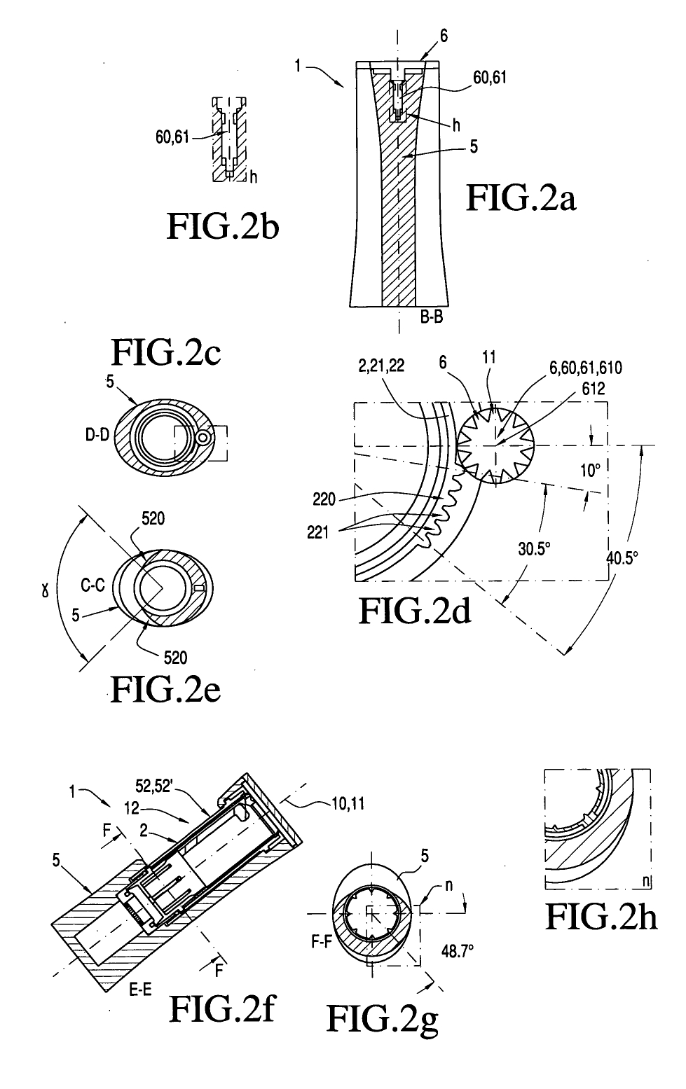

Regardless of the embodiment, and as illustrated in FIG. 2e and also in FIG. 10a, the said lateral recess (52, 52′, 52″) may have an angular opening γ typically varying from 90° to 180°, so as to enable easy access for the said finger or the said distal phalange. This angular opening γ is measured from the main axis of rotation (11).

As is clearly shown in FIG. 2e, the side edges (520) of the said lateral recess (52, 52′, 52″) of the said shell (5) are bevelled, the said bevel typically being tangent to the said spiral (2) so as to facilitate manual rotation of the said spiral (2).

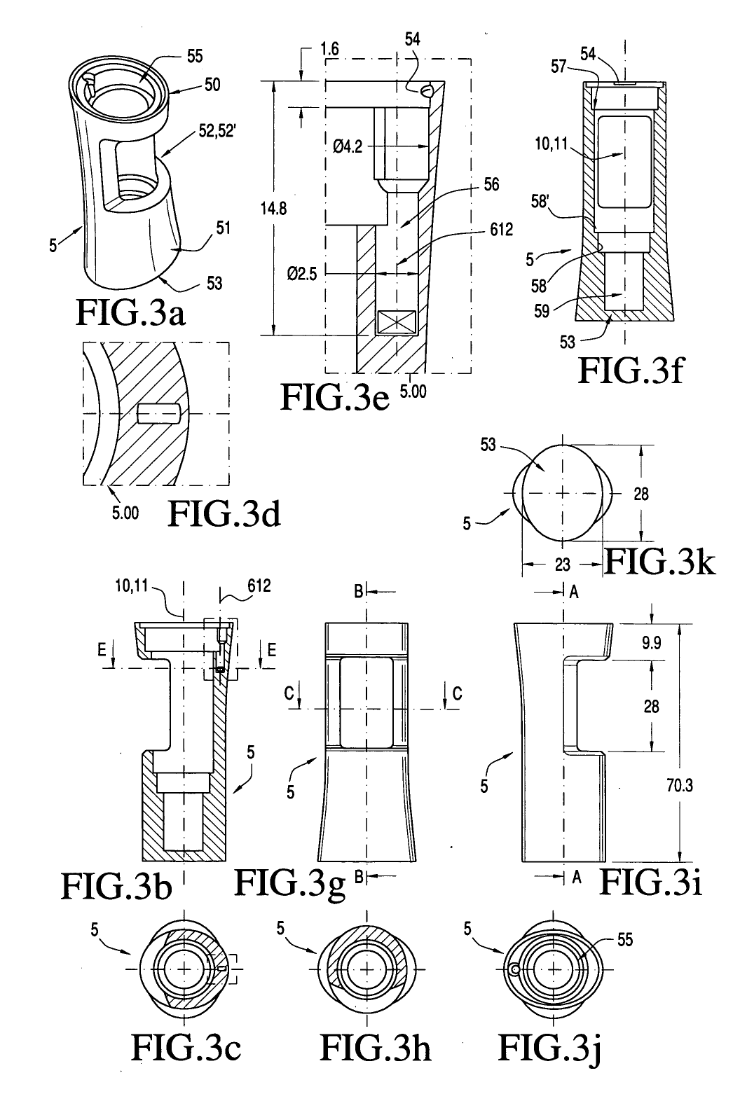

According to the invention, the said shell (5) may comprise a typically closed bottom (53) as illustrated in FIG. 2f in which the said lower part (31) of the said guide (3) is fixed, typically by force fitting. As can be seen in FIGS. 2f and 3f, this bottom (53) may comprise an inner stepped profile, with a first step forming a lower inside shoulder (58) used for force fitting of the guide (3), with a second step forming a lower inner shoulder (58′) with an annular space that enables rotation of the spiral (2).

The bottom is recessed below the first step and is profiled to give the said distributor (1) the required appearance, and in particular it may have an oval section like the cover, but the oval of the bottom may be oriented in the same way as the oval of the cover, or it may make an angle of 90° with the oval of the cover, as illustrated in FIGS. 1b and 1g.

This bottom may also be open and in this case it may be used to contain an accessory or a means of application or a complementary cosmetic.

Advantageously, the dimensions of the said spiral (2), the said guide (3) and the said shell (5) may be chosen to have a radial clearance (13) typically varying between 0.05 mm and 1 mm, and/or they may comprise low annular contact areas typically less than 5 mm high, so as to facilitate the said manual rotation of the said mobile turn with respect to the said fixed shell (5) and the said fixed guide (3), by reducing friction forces.

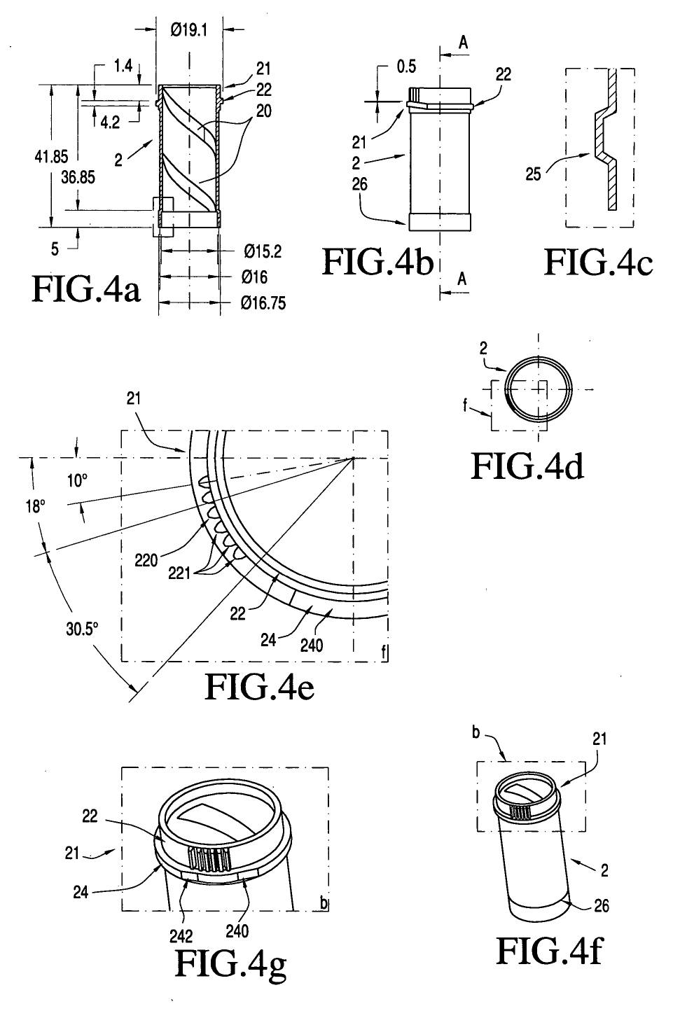

As illustrated particularly in FIGS. 4a, 4b, 4e, 4g and 4f, the said spiral (2) may include or form a ring (22) at its top part (21), for which an angular portion is toothed on the outside, the said toothed part (220) cooperating with the said rotation means (60) of the said cover (6).

As illustrated in FIGS. 10a to 10c, the said spiral (2) may include a typically knurled wheel (23) at its top part (21), in which manual rotation forms the said manual movement that causes rotation of the said cover (6) to open it and close it, and axial displacement of the said stick product, to extend it outside the distributor (1) and retract it into the distributor.

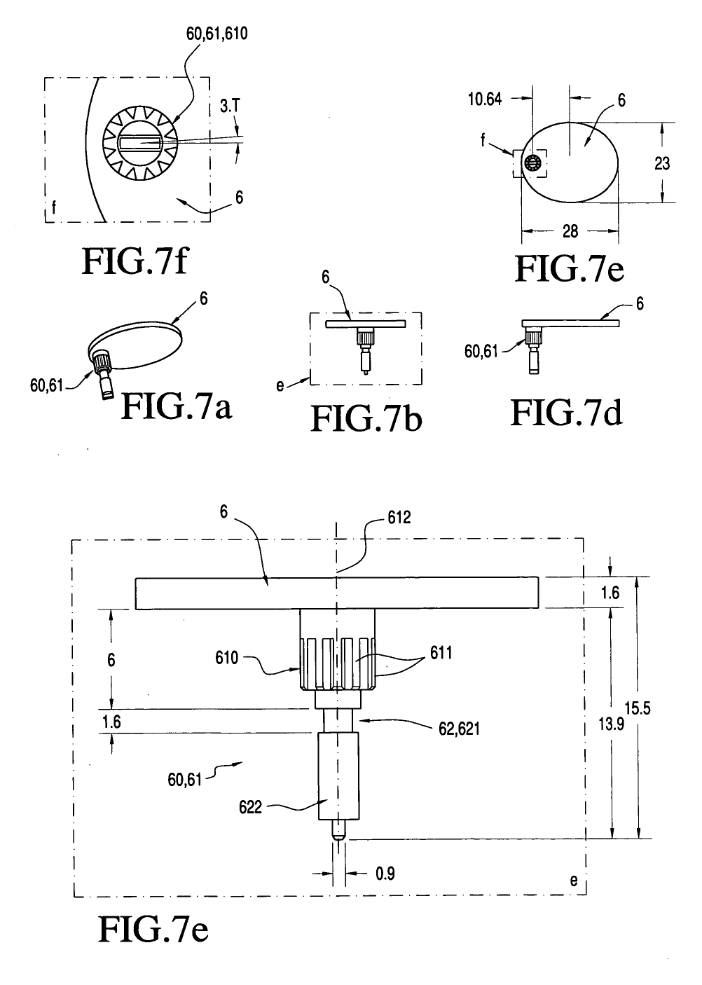

As illustrated in FIGS. 7a to 7f, the said cover (6), typically plane and perpendicular to the said axial direction (10), may include an axial rod (61) forming a pivot for the said cover (6), the said axial rod (61) being fixed to the said shell (5) in the axial direction and located between the said spiral (2) and the said shell (5) at its top part (50), the said axial rod (61) being toothed over all or part of its height, with a toothed part (610) capable of cooperating with the said toothed part (220) of the said ring (22) as a function of the angle α indicating the angular orientation of the said spiral (2) with respect to the said shell (5) or the said guide (3), so as to form the said rotation means (60), the opening of the said cover (6) including a rotation of the said cover (6) through an angle β, typically equal to 180°, around the said axial rod (61) about a secondary axis of rotation (612), typically parallel to the said main axis of rotation (11), by the said toothed part (220) of the said ring (22) becoming meshed with the said toothed part (610) of the said axial rod (61), the said toothed part (610) of the said axial rod (61) and the said toothed part (220) of the said ring (22) containing teeth typically oriented along the said axial direction (10).

FIGS. 1a and 1b illustrate opening of the cover with an angle β of 180°.

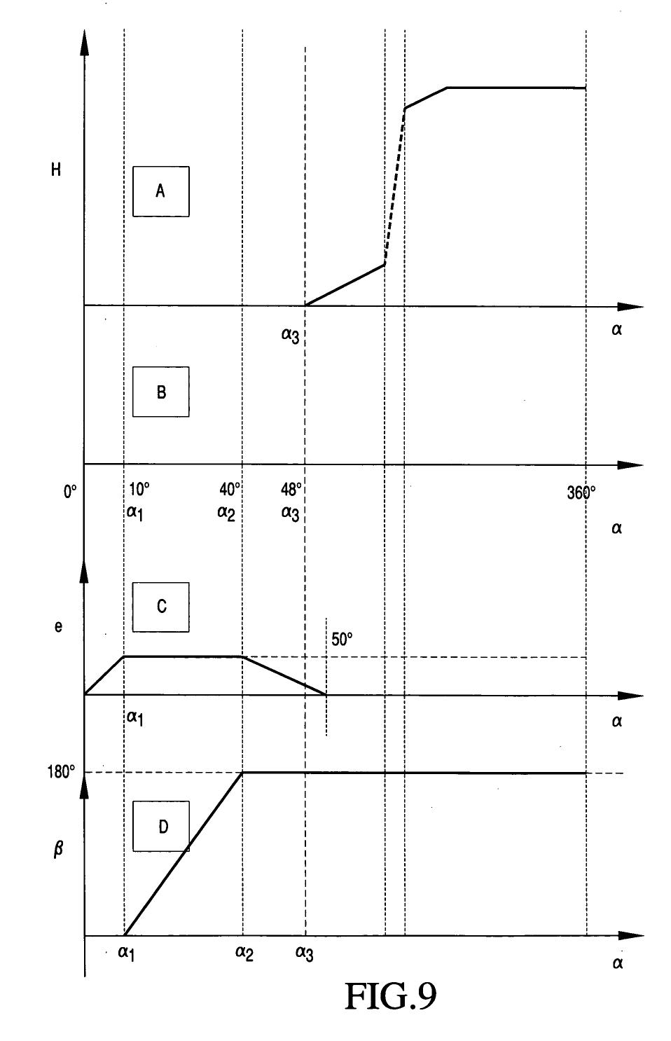

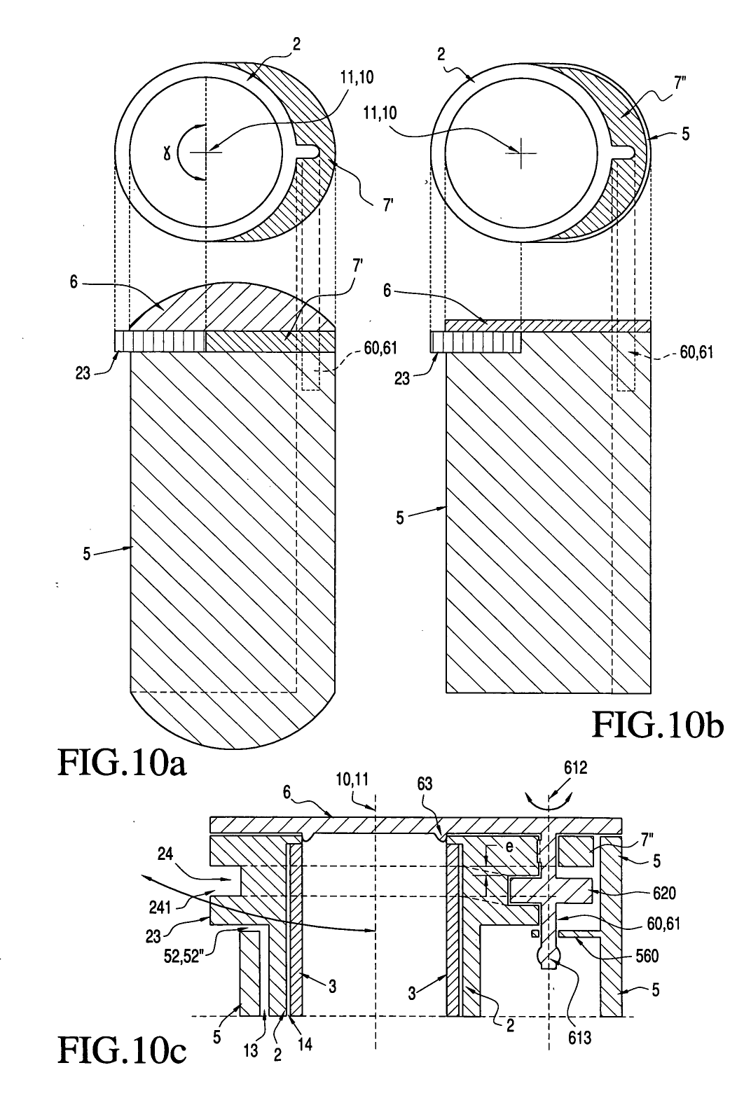

As illustrated in FIGS. 7c and 10c, the said axial rod (61) may include an axial guide means (62) of the said cover (6) cooperating with the said ring (22) such that the said cover (6) is moved axially apart from the said shell (5) or the said mechanism (12) during an initial rotation of the said ring (22) as far as an angle α₁ before the beginning of the said rotation of the cover (6), such that the said rotation of the said cover (6) is free and that there is no risk that the cover (6) will be blocked in the shell (5). See also the diagrams in FIG. 9.

In order to be able to move the cover away in the axial direction, the said ring (22) may form or include an axial guide means (24) with a height that varies as a function of the said angle α that cooperates in the axial direction with an axial guide means (62) of the said axial rod (61), so as to move the said cover apart in the axial direction by a height e typically varying from 0.1 mm to 5 mm, before the said toothed part (220) of the said ring (22) meshes with the toothed part (610) of the said axial rod (61), so that the said cover (6) can rotate.

Thus, the said guide means (24) and (62) may include a male element (240, 620) and a female element (241, 621), a male element (240) or a female element (241) of the said ring (22) cooperating with the corresponding female part (621) or male part (620) of the said axial rod (61), such that any variation in the axial height of the said axial guide means (24) of the said ring (22) causes a corresponding variation in the height of the said axial rod (61) and the said cover (6).

In the example distributor (1) according to FIGS. 1a to 8g, the guide means (24) of the spiral (2) forms a male element (240) consisting of a circular groove that cooperates with the guide means (62) of the cover (6) forming a female element (621) composed of a recessed zone on the axial rod (61) and with a smaller diameter, as can be seen in FIG. 7c.

In the example of distributors (1) according to FIGS. 10a to 10c, the guide means (24) of the spiral (2) forms a female element (241) composed of a circular groove, while the guide means (62) of the cover (6) forms a male element (620) composed of a roller or portion of the said larger diameter axial rod (60).

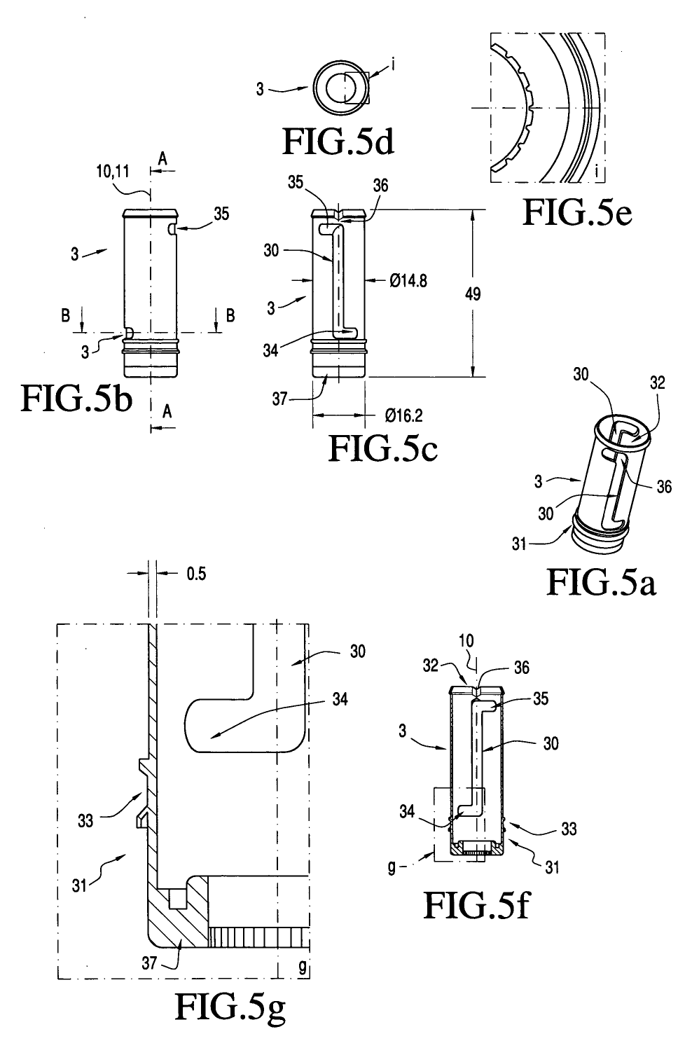

As illustrated in FIGS. 5a, 5c, 5f and 5g, each vertical groove (30) of the said guide (3) may include a lower horizontal groove (34) and typically an upper horizontal groove (35) at each end and on each side of the said vertical groove (30), the said lower horizontal groove (34) and upper horizontal groove (35) communicating with the said vertical groove (30), the said pin (40) being capable of moving along the said lower horizontal groove (34), when the said longitudinal product is retracted, with the said dish (4) being in the low position, to the said upper horizontal groove (35) when the said longitudinal product is extended, the said dish (4) being in the high position.

As can be seen in FIGS. 5a, 5c and 5f, the upper horizontal groove (35) opens outwards to force the passage of the radial pin (40) of the dish (4) during assembly of the said mechanism (12).

The said initial rotation of the said spiral as far as the said angle α₁ corresponding to the axial spacing of the said cover (6) before rotation, and then to an angle α₂ corresponding to the said rotation of the cover (6) through an angle β equal to at least 90°, typically corresponds to a displacement of the said pin (40) in the said lower horizontal groove (34), such that extension of the said longitudinal product only takes place after the said cover (6) has completely opened.

As can be seen in FIG. 9, manual rotation of the spiral (2) automatically causes a sequence of steps:
upwards movement of the cover by axial offset for α varying from 0° to α₁,
then rotation of the cover for a varying from α₁ to α₂,
and finally, axial displacement of the dish (4) and extension of the product stick for a equal to at least α₃>α₂.

As illustrated in FIG. 10c, the said cover (6) may comprise a sealing lip (63) on its inner surface designed to cooperate with the said spiral (2) and/or the said guide (3), cooperation of the said axial guide means (24) and (62) enabling axial compression of the said cover (6), typically in contact with the said spiral (2) so as to make a leak tight closure to the said upper opening.

FIG. 10c illustrates the case in which the cover (6) cooperates with the spiral (2) to make a leak tight closure.

As can be seen in FIGS. 4c and 5g, the said spiral (2) may be axially fixed to the said guide (3), typically by cooperation of click-fit means (25) and (33).

Advantageously, and particularly for aesthetic reasons, the said shell (5) may be closed off at its top end by a cache (7), particularly including a central opening (70) through which the said product passes, and possibly a lateral opening (71) through which the said axial rod (61) passes, so as to conceal the said mechanism (12) and possibly all or part of the said rotation means (60), particularly when the said cover (6) is open.

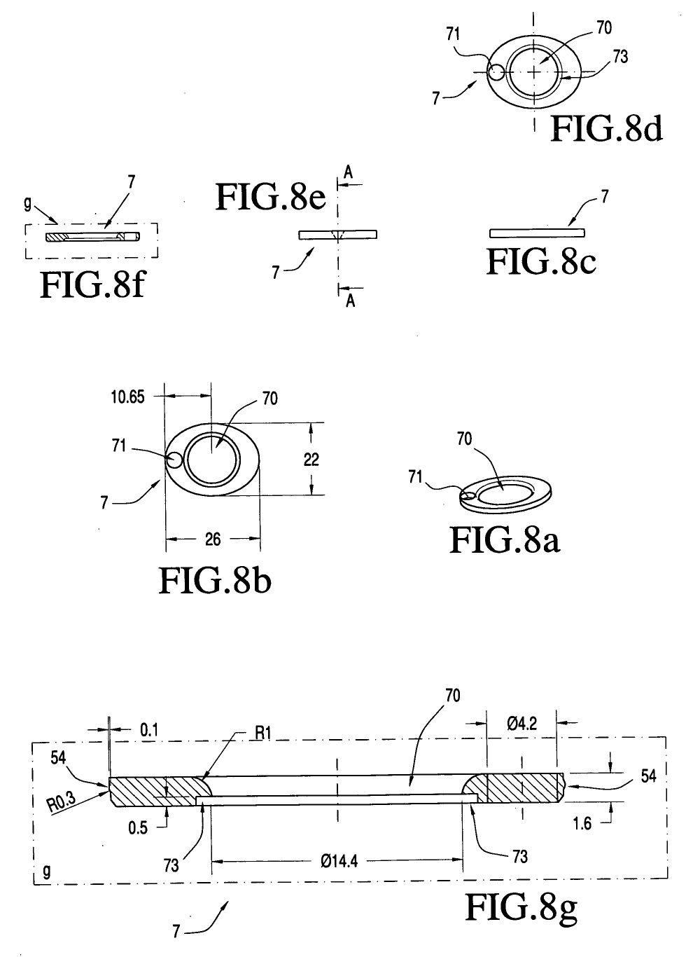

As illustrated particularly in FIGS. 8a to 8g, the said cache (7) may form a plane part perpendicular to the said axial direction (10), the said plane part being fixed to the top part (50) of the said shell (5), typically by click-fit means (54) and (72), and typically after the said mechanism (12) has been introduced into the said shell (5).

The said cache can cooperate with the said guide (3) at its top end, typically through an annular groove (73) such that since the said guide is blocked radially, the said spiral (2) coaxial with the said guide (3) is also blocked, and thus ensures cooperation between the toothed parts (220) of the said ring (22) and (610) of the said axial rod (61).

The radial width of this annular groove (73) is substantially equal to the thickness of the said guide (3), such that there is external surface continuity between the said guide (3) and the said cache (7), and thus the open distributor has an attractive appearance.

In the case of distributors (1) in FIGS. 10a to 10c, the cache (7) does not have a central opening (70), the spiral (2) containing a wheel (23) that is directly accessible. In this case, the said cache closes off the lateral spacing between the said wheel (23) and the said shell (5).

In the case of the distributor (1) in FIG. 10a, the said cache (7) is a cache (7′) with a thickness corresponding to the thickness of the said wheel (23), the said cache (7′) being fixed to the shell (5) by welding or click-fitting.

In the case of the distributor (1) in FIGS. 10b to 10c, the said cache (7) is a cache (7″) in which the thickness is concealed by the upper part (50) of the said shell (5).

According to the invention, the height H of the said shell (5) may typically vary from 40 mm to 100 mm, and it may have an arbitrary section Se, typically round, oval or square, the said section Se possibly being variable as a function of the height between the said lower part (51) and the said upper part (50), and an inner section Si, typically cylindrical, chosen to grip the said mechanism (12) and to contain the said rotation means (60).

Regardless of the embodiment or variant of the invention, the said angle α may typically vary from 72° to 360°, and will generally vary from 180° to 360°.

Advantageously, the said cover (6) may include a plane reflecting surface so as to form a mirror.

### Example Embodiments

Distributors (1) were made according to the figures according to the invention.

This was done by moulding all parts from plastic:
spiral (2) made of PP or POM
guide (3) made of PP or POM
dish (4) made of PP or POM
shell (5) made of ABS or SAN
cover (6) made of ABS or SAN
cache (7) made of ABS or PP.

The assembly of the different parts forming the said distributor (1) depends on the type of distributor.

In some cases, the first step is to assemble the dish (4) and the guide (3) and then the spiral (2), this assembly forming what is called the “propulsion mechanism” (12).

There are several possible procedures for the distributor (1) according to FIGS. 1a to 8g:
A—either, start by matching the propulsion mechanism (12) with the cache (7) and the cover (6), and then fix the assembly into the shell by click-fitting or by gluing the cache (7) to the shell (5),
B—or, typically force fit the said propulsion mechanism (12) into the said shell (5), and then assemble the cache (7) and the cover (6) by force fitting or click-fitting,
C—or, a first subassembly is formed firstly by assembling the said dish (4) into the guide (3), and the guide (3) is then fixed into the shell (5). A second subassembly is then formed composed of the cover (6), the cache (7) and the spiral (2), and it is click-fitted into the first subassembly, with the spiral click-fitting into the bottom part of the guide and the cache click-fitting into the top part of the shell.

Either method A or method B can be used for the distributors according to FIGS. 10a and 10b.

The only possible method for a distributor according to FIG. 10c is method A.

In more detail, the distributor (1) shown in FIGS. 1a to 2h comprises the following parts:
a) a shell (5) shown in FIGS. 3a to 3i. This shell includes a top opening (55) through which the propulsion mechanism (12) formed by cooperation between the spiral (2), the guide (3) and the dish (4) are formed, together with the inner shoulders: top shoulder (57) that will contain the ring (22) of the spiral (2) and two lower shoulders (58) and (581) designed to contain the guide (3) and the spiral (2) respectively, the guide (3) being fixed in the lower shoulder (58) while the spiral is free to move in the housing formed by the shoulder (58′).

The shell (5) comprises a lateral recess (52) which is a so-called “median” recess, since it is located between the top part (50) and the bottom part (51) of the shell, enabling manual access to the spiral (2) to make it rotate by an angle α with respect to the shell (5).
b) a spiral (2) shown in FIGS. 4a to 4g. This spiral (2) comprises two helical grooves on its inside surface offset by 180° from each other, each groove making an almost complete turn equal to 360°.

The lower part (26) of the spiral (2) comprises an axial click-fitting means (25) with the guide (3), this means being formed by an internal groove designed to cooperate with a click-fit means (33) of the guide formed by a pair of ribs.

The upper part (21) of the spiral (2) comprises firstly a ring (22) comprising a toothed part (220) with teeth (221) that will cooperate with the axial rod (61) of the cover (6), so as to open the cover (6) by rotation about a secondary axis of rotation (612) typically parallel to the main axis of rotation (11) and to the said axial direction (10), and secondly a means (24) of axially guiding the said axial rod (61) and the cover (6) so as to control its axial spacing when the cover (6) is opened. This axial guide means (24) forms a circular rib (240) forming a “male” guide element designed to cooperate with a female element (621) of the axial rod (61), a part (242) of this rib being offset upwards in the axial direction by a height “e” in order to impose the same axial offset on the cover (6) when it is opened.
c) a guide (3) shown in FIGS. 5a to 5g. This guide comprises two vertical grooves (30) at 180° from each other, each vertical groove (30) being prolonged by an upper horizontal groove (35) and a lower horizontal groove (34).

The upper grooves (35) include an elastic passage (36) through which the dish (4) can be inserted in the guide (3), the pins (40) then forcing the said elastic passage (36).

The guide (3) includes a bottom (37) capable of cooperating with the inner shoulder (58) of the shell (5) to fix it, typically by force fitting.

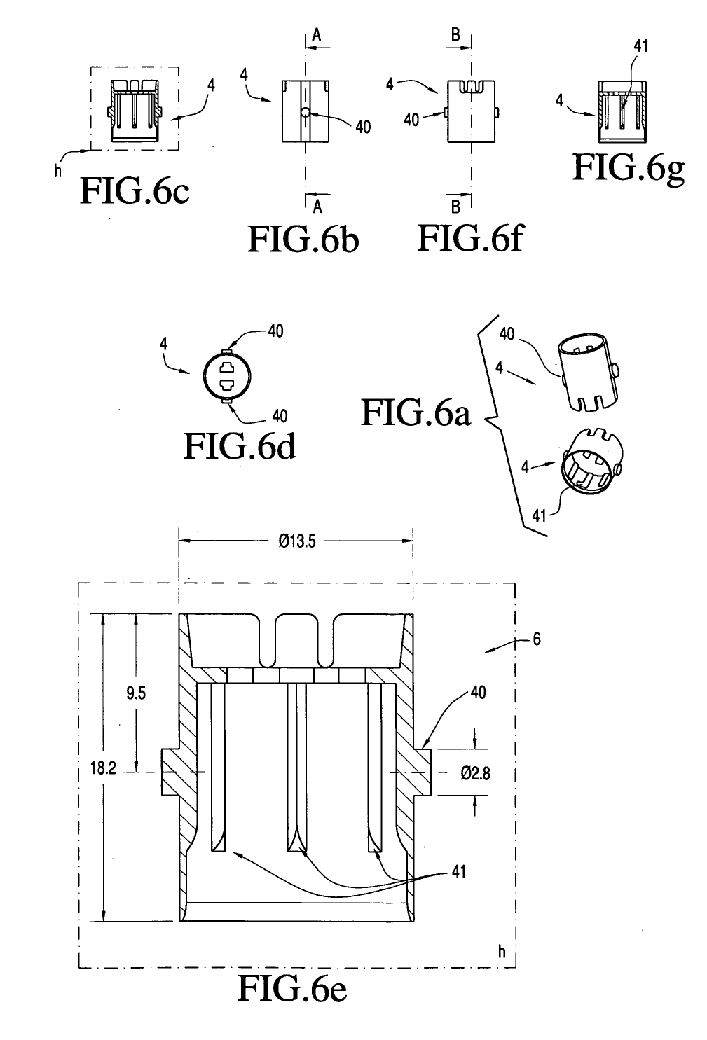

The guide (3) comprises an axial click-fit means (33) in its lower part (31), designed to cooperate with a click-fit means (25) of the spiral (2), so that the spiral can be click-fitted to the said guide (3), the spiral (2) being fixed to the said guide (3) in the axial direction, while remaining free to rotate with respect to the guide (3).
d) a dish (4) shown in FIGS. 6a to 6g. The dish (4), that was shown enlarged and in the upside down position in FIG. 6e, is used as a support for the product to be packaged. It forms a dish provided with ribs (41) on its sidewall that will fix the packaged product to the dish (4).

It comprises two radial pins (40) that will move within the grooves (30, 34, 35) of the guide (3), the end of these pins cooperating with helical grooves (20) in the spiral (2), such that relative rotation of the spiral (2) with respect to the guide (3) fixed to the shell (5) and considered as being fixed, will cause axial displacement of the dish (4) and therefore the packaged product.

The “spiral (2), guide (3) and dish (4)” assembly forms the propulsion mechanism (12).
e) a cover (6) shown in FIGS. 7a to 7f. The cover (6) comprises an axial rod (61) supporting a rotation means (60) and an axial guide means (62) cooperating with the spiral (2). The rotation means (60) is composed of a toothed wheel (610) for which the teeth (611) will mesh with the teeth (221) of the toothed part (220) of the ring (22) of the spiral (2). The axial guide means (62) forms a circular groove (621) that will cooperate with the guide groove (241) that forms the axial guide means (24) of the spiral (2). The axial rod (61) includes a lower part (622) that will be housed in the cavity (56) of the shell (5).
f) a cache (7) shown in FIGS. 8a to 8g. This cache (7) will close off the difference in section formed between the “oval” section at the top part (50) of the said shell (5) and the circular section of the propulsion mechanism (12) in general, and the spiral (2) in particular.

This cache (7) comprises a central opening (70) with a diameter substantially equal to the diameter of the said mechanism (12), so as to enable the product to be packaged to pass through.

The cache (7) comprises an annular groove (73) that cooperates with the top end of the guide (3) such that the guide (3) is blocked at its top, both in the radial and axial directions.

The cache (7) comprises a peripheral groove (54) forming a click-fit means (72) that will cooperate with a corresponding click-fit means (54) fitted on the said shell (5) at its opening (55).

FIG. 9 diagrammatically illustrates operation of the previous distributor (1) during opening or closing of the distributor corresponding to a given rotation angle α of the spiral (2) with respect to the shell (5) and the guide (3), the angle marked as the abscissa, with remarkable values of this angle α (α₁, α₂, α₃) being marked on part B.

Part A indicates the axial displacement of the dish (4) and therefore the packaged product starting from the angle α₃, for which the cover (6) is fully open.

Part C indicates the axial displacement e of the cover (6), the cover (6) being separated from the shell (5) typically between angles α₁ and α₂.

Part D indicates opening of the cover by rotation through an angle β equal to 180° when the angle α changes from a value of α₁ to α₂.

The FIGS. 10a to 10c show different embodiments of distributors (1) according to the invention.

In these distributors (1), the shell (5) comprises an upper recess (52, 52″) that is at least partly coincident with its top opening (55). In this case, the upper part of the spiral (2) is provided with a knurled wheel (23) that can be turned manually.

These distributors (1) typically comprise a half-moon shaped cache (7). In the distributor (1) according to FIG. 10a, the edge of the cache (7′) can be seen when the distributor (1) is closed, while in the distributor (1) according to FIGS. 10b and 10c, the cache (7″) is not visible when the distributor (1) is closed.

These distributors (1) are assembled as follows: the first step is to assemble the propulsion mechanism (12), forming an assembly by laterally assembling the propulsion mechanism (12), the cover (6), and then the cache (7′) or (7″).

This assembly is then inserted into and fixed in the shell (5), the bottom (37) of the guide (3) being fixed to the shell (5) typically by force fitting, the upper part of the said assembly being fixed to the shell either typically by welding or gluing the said cache (7′,7″) to the shell (5), and/or by click-fitting the axial rod (61) of the cover (6), and typically its lower end (613) in a click-fit means (560) of the shell (5), for example as shown in FIG. 10c.

### ADVANTAGES OF THE INVENTION

The invention divulges stick product distributors with many advantages.

Apart from the fact that a “one-hand” distributor is obtained, the invention can be used to produce a number of very different distributors, with differences in their appearance and the gestures necessary to operate them.

All these distributors are very clearly distinguished from distributors according to the state of the art, both for “one-hand” distributors according to the state of the art and for “standard” distributors provided with a propulsion mechanism with a “spiral+guide+dish” assembly.

Thus, the invention satisfies market needs by simultaneously satisfying technical requirements and a “marketing” requirement.

Moreover, distributors according to the invention can typically be assembled by axial click-fitting, which is very useful in practice to achieve manufacturing with high productivity.

List of marks

| | |
|---|---|
| Distributor | 1 |
| Axial direction | 10 |
| Main rotation axis | 11 |
| Propulsion mechanism = 2 + 3 + 4 | 12 |
| Radial clearance between 2 and 5 | 13 |
| Radial clearance between 2 and 3 | 14 |
| Spiral | 2 |
| Helical groove | 20 |
| Upper part | 21 |
| Ring | 22 |
| Toothed part | 220 |
| Teeth of 220 | 221 |
| Knurled wheel | 23 |
| Axial guide means of 61 | 24 |
| Male element = edge of 22 | 240 |
| Female element = groove | 241 |
| Axial offset part of e | 242 |
| Click-fit means with 33 | 25 |
| Lower part | 26 |
| Guide | 3 |
| Vertical grooves | 30 |
| Lower part | 31 |
| Upper opening | 32 |
| Click-fit means with 25 | 33 |
| Lower horizontal groove | 34 |
| Upper horizontal groove | 35 |
| Narrowing for passage of 40 | 36 |
| Bottom | 37 |
| Dish | 4 |
| Radial pin | 40 |
| Lipstick attachment ribs | 41 |
| Shell | 5 |
| Upper part | 50 |
| Lower part | 51 |
| Lateral recess or window | 52 |
| Median recess | 52′ |
| Upper recess | 52″ |
| Side edges | 520 |
| Bottom | 53 |
| Click-fit means with 72 | 54 |
| Opening | 55 |
| Cavity - housing of 612 | 56 |
| Click-fit means of 613 | 560 |
| Upper inner shoulder for 22 | 57 |
| Lower inner shoulder for 3 | 58 |
| Lower inner shoulder for 2 | 5 8′ |
| Lower cavity | 59 |
| Cover (closing means) | 6 |
| Rotation means cooperating with 2 | 60 |
| Axial rod | 61 |
| Toothed part cooperating with 220 | 610 |
| Teeth of 610 | 611 |
| Secondary rotation axis | 612 |
| Click-fit means with 560 | 613 |
| Axial guide means of 61 | 62 |
| Male element | 620 |
| Female element | 621 |
| Lower part | 622 |
| Sealing lip | 63 |
| Cache | 7 |
| Cache in FIG. 10a | 7′ |
| Cache in FIGS. 10b and 10c | 7″ |
| Central opening | 70 |
| Lateral opening | 71 |
| Click-fit means with 54 | 72 |
| Annular groove | 73 |

1. Longitudinal distributor (1) along an axial direction (10), to package a longitudinal stick product and typically a lipstick, comprising an axial propulsion mechanism (12) for the said longitudinal product, comprising a) a cylindrical element called a “spiral” (2) provided with at least one and typically two helical grooves (20) on its inside surface, b) a grooved tubular rod called a “guide” (3) with at least one vertical groove (30) and typically two opposed vertical grooves, the said guide (3) forming a wall coaxial to the said spiral (2) and located on the inside of the said spiral, c) a dish (4) acting as a support for the said longitudinal product, the said dish (4) comprising at least one and typically two radial pins (40), each radial pin (40) cooperating with a helical groove (20) through a vertical groove (30), such that relative rotation of the said spiral (2) with respect to the said guide (3) along a main axis of rotation (11) parallel to the said axial direction (10) causes axial displacement of the said dish (4) and the said stick product and forces it to move outwards through an upper opening (32) of the said guide, and d) a means of closing off the said upper opening, and is characterised in that:
1) the said distributor (1) comprises an outer shell or gripping case (5) enclosing on the said mechanism (12), the said shell (5) comprising a typically cylindrical inner surface adapted to the said mechanism (12), the said shell (5) being open (55) in its upper part (50) to allow notably the said stick product and possibly the said mechanism (12) to pass through to form an assembly with the said shell (5),
2) the said shell (5) comprises a lower part (51) cooperating with the lower part (31) of the said guide (3), such that the said guide (3) is fixed particularly in rotation with respect to the said shell (5), the said spiral (2) being mobile in rotation with respect to the said shell (5) and the said guide (3),
3) the said shell (5) comprises a means of access to the said spiral (2), so that when the said shell (5) is gripped in one hand, the said spiral (2) can be rotated manually with a finger of the same hand,
4) the said distributor (1) comprises a cover (6) intended to form the said means of closing off the said upper opening (32), the said cover (6) being fixed to the said shell (5) at its top (50) and that can be opened or closed by manual rotation of the said spiral (2), by a means of rotation (60) of the said cover (6) cooperating with the said spiral (2), such that the said distributor (1) is a “one hand” distributor, the said manual rotation of the said spiral (2) through an angle α with respect to the said shell (5), typically being made using one finger of the said hand or a distal phalange of the said finger, the said manual rotation comprising firstly a “forward” rotation causing a “forward”rotation of the said cover (6) in order to disengage the said upper opening (32), and then extension of the said stick product by axial displacement outside the distributor and finally, after the said stick product has been applied, including a “backward” or inverse manual rotation of the said spiral (2), making the said stick product retract into the distributor, and a “backward” rotation of the said cover (6) to close off the said upper opening (32).

2. Distributor according to claim 1, in which the said access means comprises or is composed of a median lateral recess (52) located between the said top part (50) and the said bottom part (51) of the said shell (5), over a height Ha equal to at least 20 mm and typically varying from 25 mm to 40 mm, so as to enable direct and easy access for the said finger or the said distal phalange.

3. Distributor according to claim 1, in which the said access means comprises or is composed of an upper lateral recess (52′) located at the said upper part (50) of the said shell (5), over a height Ha′ typically varying from 3 mm to 15 mm.

4. Distributor according to claim 1, in which the said access means is composed of the said opening (55) of the said shell.

5. Distributor according to claim 1, in which the said lateral recess (52, 52′) has an angular opening y typically varying from 90° to 180°, so as to enable easy access for the said finger or the said distal phalange.

6. Distributor according to claim 1, in which the said shell (5) comprises a typically closed bottom (53) in which the said lower part (31) of the said guide (3) is fixed, typically by force fitting.

7. Distributor according to claim 1, in which the said spiral (2), the said guide (3) and the said shell (5) may be chosen to have a radial clearance (13) typically varying between 0.05 mm and 1 mm, and/or they may comprise low annular contact areas typically less than 5 mm high, so as to facilitate the said manual rotation of the said mobile turn with respect to the said fixed shell (5) and the said fixed guide (3), by reducing friction forces.

8. Distributor according to claim 1, in which the said spiral (2) includes or forms a ring (22) at its top part (21), for which an angular portion is toothed on the outside, the said toothed part (220) cooperating with the said rotation means (60) of the said cover (6).

9. Distributor according to claim 3, in which the said spiral (2) includes a typically notched knurled wheel (23) at its top part (21), in which manual rotation forms the said manual movement that causes rotation of the said cover (6) to open it and close it, and axial displacement of the said stick product, to extend it outside the distributor (1) and retract it into the distributor.

10. Distributor according to claim 8, in which the said cover (6), typically plane and perpendicular to the said axial direction (10), includes an axial rod (61) forming a pivot for the said cover (6), the said axial rod (61) being fixed to the said shell (5) in the axial direction and located between the said spiral (2) and the said shell (5) at its top part (50), the said axial rod (61) being toothed over all or part of its height, with a toothed part (610) capable of cooperating with the said toothed part (220) of the said ring (22) as a function of the angle α indicating the angular orientation of the said spiral (2) with respect to the said shell (1) or the said guide (3), so as to form the said rotation means (60), the opening of the said cover (6) including a rotation of the said cover (6) through an angle β, typically equal to 180°, around the said axial rod (61) about a secondary axis of rotation (612), typically parallel to the said main axis of rotation (11), by the said toothed part (220) of the said ring (22) becoming meshed with the said toothed part (610) of the said axial rod (61), the said toothed part (610) of the said axial rod (61) and the said toothed part (220) of the said ring (22) containing teeth typically oriented along the said axial direction (10).

11. Distributor according to claim 10, in which the said axial rod (61) includes an axial guide means (62) of the said cover (6) cooperating with the said ring (22) such that the said cover (6) is moved axially apart from the said shell (5) or the said mechanism (12) during an initial rotation of the said ring (22) as far as an angle α₁ before the beginning of the said rotation of the cover (6), such that the said rotation of the said cover (6) is free and that there is no risk that the cover (6) will be blocked in the shell (5).

12. Distributor according to claim 11, in which the said ring (22) forms or includes an axial guide means (24) with a height that varies as a function of the said angle α, that cooperates in the axial direction with an axial guide means (62) of the said axial rod (61), so as to move the said cover apart in the axial direction by a height e typically varying from 0.1 mm to 5 mm, before the said toothed part (220) of the said ring (22) meshes with the toothed part (610) of the said axial rod (61), so that the said cover (6) can rotate.

13. Distributor according to claim 12, in which the said guide means (24) and (62) may include a male element (240, 620) and a female element (241, 621), a male element (240) or a female element (241) of the said ring (22) cooperating with the corresponding female part (621) or male part (620) of the said axial rod (61), such that any variation in the axial height of the said axial guide means (24) of the said ring (22) causes a corresponding variation in the height of the said axial rod (61) and the said cover (6).

14. Distributor according to claim 1, in which each vertical groove (30) of the said guide (3) includes a lower horizontal groove (34) and typically an upper horizontal groove (35) at each end and on each side of the said vertical groove (30), the said lower horizontal groove (34) and upper horizontal groove (35) communicating with the said vertical groove (30), the said pin (40) being capable of moving along the said lower horizontal groove (34) when the said longitudinal product is retracted, with the said dish (4) being in the low position, to the said upper horizontal groove (35) when the said longitudinal product is extended, the said dish (4) being in the high position.

15. Distributor according to claim 14, in which the said initial rotation of the said spiral as far as the said angle α₁ corresponding to the said axial spacing of the said cover (6) before rotation, and then to an angle α₂ corresponding to the said rotation of the cover (6) through an angle β typically equal to at least 90°, corresponds to a displacement of the said pin (40) in the said lower horizontal groove (34), such that extension of the said longitudinal product only takes place after the said cover (6) has completely opened.

16. Distributor according to claim 11, in which the said cover (6) comprises a sealing lip (63) on its inner surface designed to cooperate with the said spiral (2) and/or the said guide (3), cooperation of the said axial guide means (24) and (62) enabling axial compression of the said cover (6), typically in contact with the said spiral (2) so as to make a leak tight closure of the said upper opening.

17. Distributor according to claim 1, in which the said spiral (2) is axially fixed to the said guide (3), typically by cooperation of click-fit means (25) and (33).

18. Distributor according to claim 1, in which the said shell (5) is closed off at its top end by a cache (7), particularly including a central opening (70) through which the said product passes, and possibly a lateral opening (71) through which the said axial rod (61) passes, so as to conceal the said mechanism (12) and possibly all or part of the said rotation means (60), particularly when the said cover (6) is open.

19. Distributor according to claim 18, in which the said cache (7) forms a plane part perpendicular to the said axial direction (10), the said plane part being fixed to the top part (50) of the said shell (5), typically by click-fit means (54) and (72), and typically after the said mechanism (12) has been introduced into the said shell (5).

20. Distributor according to claim 19, in which the said cache cooperates with the said guide (3) at its top end, typically through an annular groove (73) such that since the said guide is blocked radially, the said spiral (2) coaxial with the said guide (3) is also blocked, and thus ensures cooperation between the toothed parts (220) of the said ring (22) and (610) of the said axial rod (61).

21. Distributor according to claim 1, in which the height H of the said shell (5) typically varies from 40 mm to 100 mm, and it may have an arbitrary section Se, typically round, oval or square, the said section Se possibly being variable as a function of the height between the said lower part (51) and the said upper part (50), and an inner section Si, typically cylindrical, chosen to grip the said mechanism (12) and to contain the said rotation means (60).

22. Distributor according to claim 1, in which the said angle α typically varies from 72° to 360°.

23. Distributor according to claim 1, in which the said cover (6) includes a plane reflecting surface so as to form a mirror.
